(19) United States
(12) Patent Application Publication
(10) Pub. No.: US 2007/0078830 A1
(43) Pub. Date: Apr. 5, 2007

(54) METHOD AND SYSTEM FOR RETRIEVING INFORMATION AND IP SETTING INTERFACE

(76) Inventors: Yong-Ping Zheng, Taipei (TW); David Ho, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/309,557

(22) Filed: Aug. 22, 2006

(30) Foreign Application Priority Data
Aug. 22, 2005 (TW) 94128591

(51) Int. Cl. G06F 17/30

(52) U.S. Cl. 707/3

(57) ABSTRACT

A system and a method for retrieving information, and an IP setting interface are provided, which are applicable to a portable communication apparatus. The system comprises a retrieving user interface, a code correspondence table, and a comparison module. The retrieving user interface provides the portable apparatus to input an inquiry code and to output a retrieved result. The code correspondence table maps a set of default area code data to a set of default inquiry code data corresponding to the set of default area code data. The comparison module compares the inquiry code and the set of default inquiry code data and obtains an area code as a retrieved result. Furthermore, the purposes of fast retrieval of the area code and fast dialing can be achieved, and the convenience of the portable communication apparatus can be improved.

### CROSS-REFERENCE TO RELATED APPLICATION

This application claims the priority benefit of Taiwan application Ser. No. 941 28591, filed on Aug. 22, 2005. All disclosure of the Taiwan application is incorporated herein by reference.

### BACKGROUND OF THE INVENTION

1. Field of Invention

The present invention relates to a system and a method for retrieving information, and an IP (Internet Protocol) setting interface. More particularly, the present invention relates to a system and a method for retrieving information, and an IP setting interface applicable to a portable communication apparatus.

2. Description of Related Art

With the increasing convenience of function of mobile phones, mobile phones have become indispensable tools in daily life. Conventionally, when making a domestic phone call, an area code must be added before a communication number to finish dialing. When storing a domestic communication number in a telephone book, an area code must be input together. As such, a direct calling can be made when giving a call next time. However, when storing the communication number, people easily forget to input the area code, and when calling, find that the area code has not been added before the stored communication number, resulting in the inconvenience of use. Meanwhile, conventional mobile phones do not provide the quick and convenient method for retrieving the area code, so another ways should be used to search the desired area code.

Moreover, Internet and other IP networks are also quickly developed, and the combination of the mobile phone and the IP network generates the application of the IP telephone. Conventionally, when using the IP telephone, an IP code must be input first, and the communication number is dialed, thus finishing dialing. The process of dialing is not only time-consuming, but also troublesome.

In view of the above problems in the conventional art, the present inventor, based on years of research and development of the portable communication apparatus and practical experiences, provides a system and a method for retrieving information, and an IP system, which are applicable to the portable communication apparatus, so as to achieve and give reference to the above purpose.

### SUMMARY OF THE INVENTION

Accordingly, the present invention is directed to provide a system for retrieving information, which is applicable to a portable communication apparatus such as the mobile phone. The present system comprises a retrieving user interface, a code correspondence table, and a comparison module. The retrieving user interface is used by a user for inputting an inquiry code into the portable communication apparatus, and in response the retrieving user interface outputs a retrieved result. The code correspondence table maps a set of default area code data to a set of default inquiry code data such as a default phonetic code or a default stroke code corresponding to the default area code data. The set of default area code data comprises a default area name and a default area code. The comparison module is used to compare the inquiry code and the set of default inquiry code data and obtains an area code of the set of default area code data as the retrieved result corresponding to the inquiry code, and the area code comprises an area name and an area number or a dialing code.

The present invention provides a method for retrieving information, which is applicable to a portable communication apparatus such as the mobile phone, and the method comprises the following steps. A code correspondence table mapping a set of default area code data to a set of default inquiry data corresponding to the set of default area code data is preset. A phonetic or stroke inquiry code is input through a retrieving user interface. The inquiry code and the set of default inquiry code data are compared by the use of the comparison module to obtain an area code of the set of default area code data. Finally, a retrieved result of the area code is displayed through the retrieving user interface, and the area code comprises an area name and an area number or a dialing code.

The present invention provides an IP setting interface, which is applicable to a portable communication apparatus such as the mobile phone, so as to make an IP phone call. The interface comprises at least an IP prefix menu and an identification menu. An IP prefix is input through the IP prefix menu and an identification number and a password are input through the identification menu, so as to make the IP phone call. The identification number and the password are provided by a telephone card. The IP setting interface is used to simplify the dialing process when making the IP phone call.

Moreover, the phonetic inquiry code comprises acronyms of the characters of the inquired area name. The stroke inquiry code comprises the number of stokes of the characters of the inquired area name. If the area name exceeds two characters, the number of stokes of the first two characters is selected. The input method can also be used in other operating interfaces of the portable communication apparatus.

In order to the make aforementioned and other objects, features and advantages of the present invention comprehensible, preferred embodiments accompanied with figures are described in detail below.

### BRIEF DESCRIPTION OF THE DRAWINGS

FIG. 1 is a schematic view of a system for retrieving information provided by the present invention.

FIG. 2 is a flow chart of a method for retrieving information provided by the present invention.

FIG. 3 is a flow chart of the dialing process of the system for retrieving information of the present invention.

FIG. 4 is a schematic view of the code correspondence table of the system for retrieving information of the present invention.

FIG. 5 is a schematic view of the display frame of inputting a retrieving code of the system for retrieving information of the present invention.

FIG. 6 is a schematic view of the display frame of outputting a retrieved result of the system for retrieving information of the present invention.

FIG. 7 is a schematic view of the IP setting interface provided by the present invention.

FIG. 8 is a flow chart of the dialing process of the IP setting interface of the present invention.

### DESCRIPTION OF EMBODIMENTS

The system and the method for retrieving information, and the IP setting interface according to the preferred embodiments of the present invention are illustrated with reference to the relative drawings as follows, wherein the same elements are illustrated with the same reference symbols.

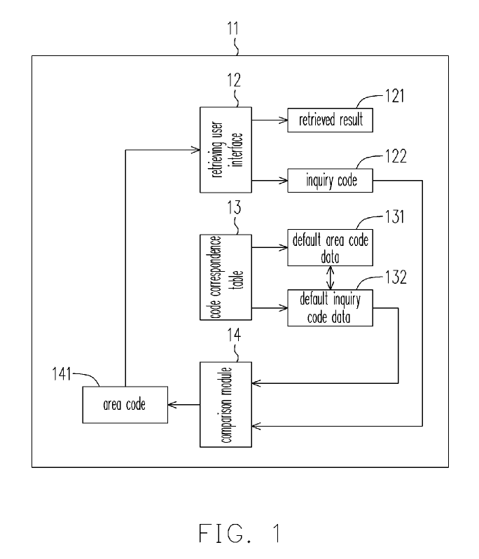

Referring to FIG. 1, it is a schematic view of a system for retrieving information provided by the present invention, which is applicable to a portable communication apparatus. As shown in the figure, a system for retrieving information 11 comprises at least a retrieving user interface 12, a code correspondence table 13, and a comparison module 14. The retrieving user interface 12 is an output and input interface for outputting a retrieved result 121 and for inputting an inquiry code 122. The correspondence code table 13 maps a set of default area code data 131 to a set of default inquiry code data 132 corresponding to the set of default area code data 131. The comparison module 14 compares the inquiry code 122 and the set of default inquiry code data 132 of the code correspondence table 13, so as to obtain an area code 141. Finally, the retrieved result 121 of the area code 141 is displayed through the retrieving user interface 12.

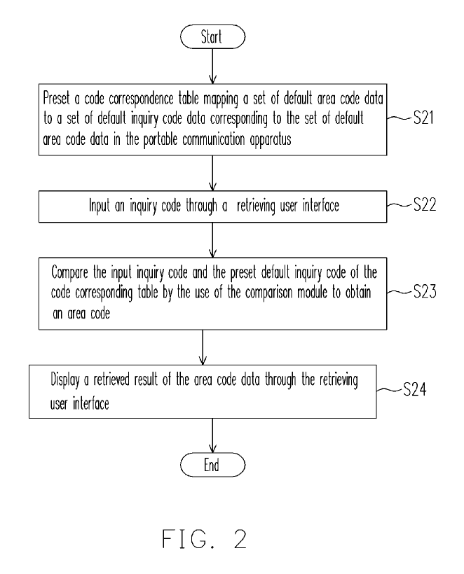

Referring to FIG. 2, it is a flow chart of a method for retrieving information provided by the present invention, which is applicable to a portable communication apparatus. The method comprises at least the following steps. First, a code correspondence table mapping a set of default area code data to a set of default inquiry code data corresponding to the set of default area code data is preset in the portable communication apparatus (S21). An inquiry code is input through a retrieving user interface (S22). The input inquiry code and the preset default inquiry code of the code corresponding table are compared by the use of the comparison module, so as to obtain an area code (S23). A retrieved result of the area code data is displayed through the retrieving user interface (S24), and then the flow is completed.

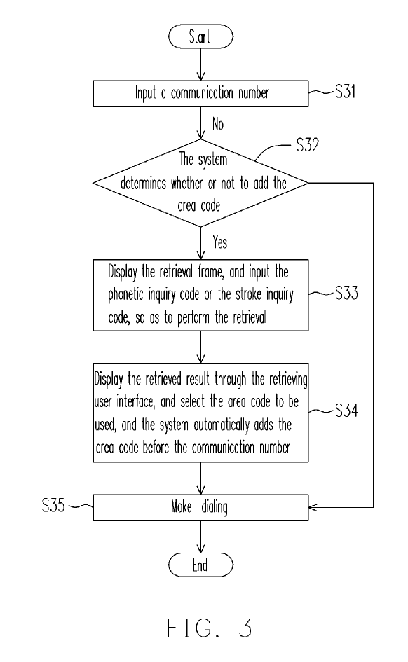

Next, referring to FIG. 3, it is a flow chart of the dialing process of the system for retrieving information of the present invention. The dialing process is, for example, making a domestic phone call, and comprises at least the following steps. First, a communication number is input (S31). The system determines whether or not to add the area code (S32). If yes, the retrieval frame is displayed, and the phonetic inquiry code or the stroke inquiry code is input to make the retrieval (S33). Next, the retrieved result is displayed and the area code to be used is selected through the retrieving user interface, and the system automatically adds the area code before the communication number (S34). Thereafter, the dialing is made (S35). If no, the direct dialing can be made (S35), and then the flow is completed.

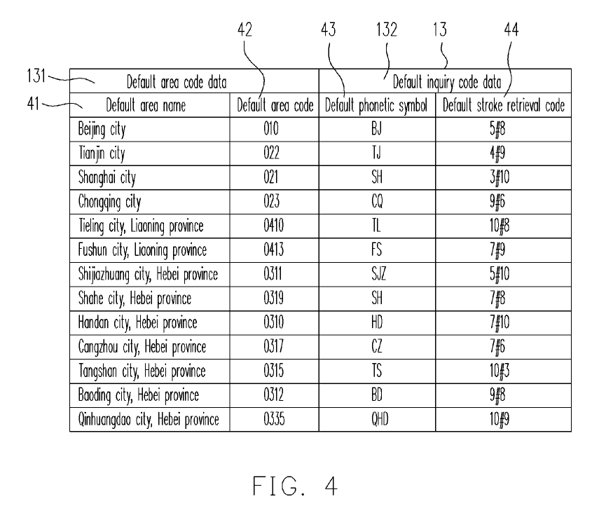

Then, referring to FIG. 4, it is a schematic view of the code correspondence table of the system for retrieving information of the present invention. As shown in the figure, the code correspondence table 13 maps a set of default area code data 131 to a set of default inquiry code data 132. The set of default area code data 131 further comprises a default area name 41 and a default area code 42. The default inquiry code data 132 further comprises a default phonetic symbol 43 representing a character of a default area name corresponding to a default area code of the set of default area code data and a default stroke retrieval code 44 representing the number of total strokes of a character of a default area name corresponding to a default area code of the set of default area code data. For example, for Beijing city, the area code is 010. The acronyms of the characters of “ [symbol] ” and “ [symbol] ” are “B” and “J”, and the default phonetic symbol 43 is BJ. Moreover, the numbers of strokes of “ [symbol] ” and “ [symbol] ” are respectively five and eight, so the default stroke retrieval code 44 is “5#8”, and so forth.

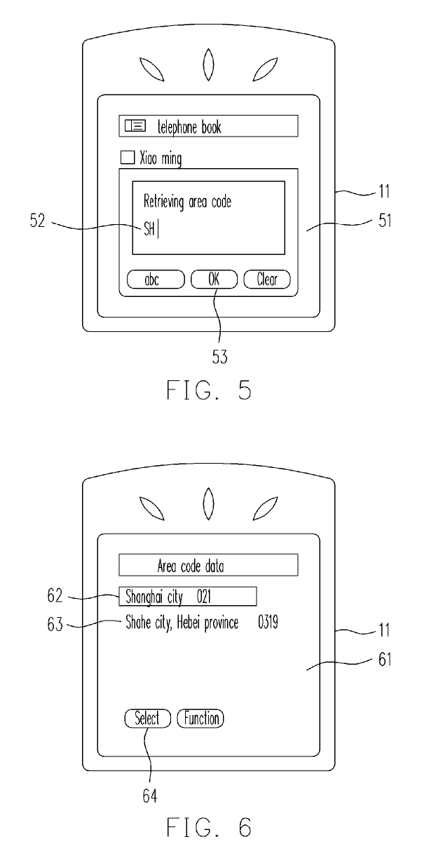

Referring to FIG. 5, it is a schematic view of the display frame of inputting a retrieving code of the system for retrieving information of the present invention, which is displayed on the portable communication apparatus 11. In the figure, the retrieving of Shanghai city is taken as an example. The inquiry code of the English letters “SH” 52 corresponding to the acronyms of the characters of “ [symbol] ” and “ [symbol] ” is input to the display input frame 51, and then input the OK button 53, thus performing the retrieving of area code.

Referring to FIG. 6, it is a schematic view of the display frame of outputting a retrieved result of the system for retrieving information of the present invention, which is displayed on a portable communication apparatus 11. In the figure, the input of the retrieving code of “SH” is taken as an example. The retrieved result of “Shanghai city 021” 62 and “Shahe city, Hebei province 0319” 63 is displayed in the frame 61, select the “Shanghai city 021” 62 to be retrieved, and press the select button 64.

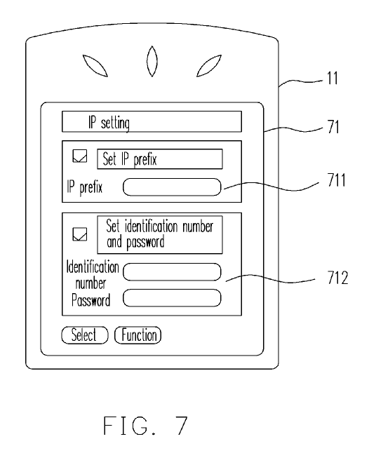

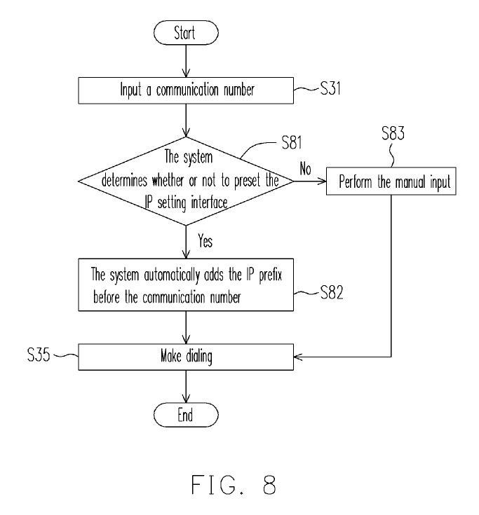

Referring to FIG. 7, it is a schematic view of the IP setting interface provided by the present invention, which is applicable to a portable communication apparatus 11, so as to make an IP phone call. As shown in the figure, the IP setting interface 71 comprises an IP prefix menu 711 and an identification menu 712. An IP prefix is input through the IP prefix menu 711, and the identification number and the password provided by the telephone card are input through the identification menu 712, so as to make the IP phone call.

Referring to FIG. 8, it is a flow chart of the dialing process of the IP setting interface of the present invention, and the dialing process is, for example, making a domestic phone call by the use of IP telephone, and comprises at least the following steps. First, a communication number is input (S31). The system determines whether or not to preset the IP setting interface (S81). If yes, the system automatically adds the IP prefix before the communication number (S82), so as to perform the dialing (S35). If no, a manual input is required (S83). After finishing the manual input, the dialing is made (S35), and then the flow is complete.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A system for retrieving information, applicable to a portable communication apparatus, comprising:
a retrieving user interface by which a user inputs an inquiry code into the portable communication apparatus, and in response the retrieving user interface outputs a retrieved result;
a code correspondence table mapping a set of default area code data to a set of default inquiry code data corresponding to the set of default area code data; and
a comparison module comparing the inquiry code and the set of default inquiry code data and obtaining an area code of the set of default area code data as the retrieved result corresponding to the inquiry code.

2. The system for retrieving information as claimed in claim 1, wherein the portable communication apparatus is a mobile phone.

3. The system for retrieving information as claimed in claim 1, wherein the inquiry code comprises a phonetic symbol representing a character of a default area name corresponding to a default area code of the set of default area code data.

4. The system for retrieving information as claimed in claim 1, wherein the inquiry code comprises a number of total strokes of a character of a default area name corresponding to a default area code of the set of default area code data.

5. The system for retrieving information as claimed in claim 1, wherein the set of default area code data comprises a default area name.

6. The system for retrieving information as claimed in claim 1, wherein the set of default area code data comprises a default area code.

7. The system for retrieving information as claimed in claim 1, wherein each of the set of default inquiry code data comprises phonetic symbols representing characters of a default area name corresponding to a default area code of the set of default area code data.

8. The system for retrieving information as claimed in claim 1, wherein each of the set of default inquiry code data comprises numbers of total strokes of characters of a default area name corresponding to a default area code of the set of default area code data.

9. The system for retrieving information as claimed in claim 1, wherein the area code comprises an area name.

10. The system for retrieving information as claimed in claim 1, wherein the area code comprises an area number or a dialing code.

11. A method for retrieving information, applicable to a portable communication apparatus, comprising:
setting a code correspondence table mapping a set of default area code data to a set of default inquiry code data corresponding to the set of default area code data;
inputting an inquiry code through a retrieving user interface into the portable communication apparatus;
comparing the inquiry code and the set of default inquiry code data and obtaining an area code of the set of default area code data as a retrieved result corresponding to the inquiry code; and
outputting the retrieved result through the retrieving user interface.

12. The method for retrieving information as claimed in claim 11, wherein the portable communication apparatus is a mobile phone.

13. The method for retrieving information as claimed in claim 11, wherein the set of default area code data comprises a default area name.

14. The method for retrieving information as claimed in claim 11, wherein the set of default area code data comprises a default area code.

15. The method for retrieving information as claimed in claim 11, wherein each of the set of default inquiry code data comprises phonetic symbols representing characters of a default area name corresponding to a default area code of the set of default area code data.

16. The method for retrieving information as claimed in claim 11, wherein each of the set of default inquiry code data comprises numbers of total strokes of characters of a default area name corresponding to a default area code of the set of default area code data.

17. The method for retrieving information as claimed in claim 11, wherein the inquiry code comprises a phonetic symbol representing a character of a default area name corresponding to a default area code of the set of default area code data.

18. The method for retrieving information as claimed in claim 11, wherein the inquiry code comprises a number of total strokes of a character of a default area name corresponding to a default area code of the set of default area code data.

19. The method for retrieving information as claimed in claim 11, wherein the area code comprises an area number or a dialing code.

20. The method for retrieving information as claimed in claim 11, wherein the area code comprises an area name.

21. An IP setting interface, applicable to a portable communication apparatus for making a call using an IP telephone, the IP setting interface comprising:
an IP prefix menu setting an IP prefix for making a call using the IP telephone; and
an identification menu for inputting an identification number and a password when using the IP telephone,
wherein when dialing a telephone number using the IP telephone and the IP prefix is set, the IP prefix is automatically dialed before the telephone number is dialed to complete making the call.

22. The IP setting interface as claimed in claim 21, wherein the identification number is provided by a telephone card.

23. The IP setting interface as claimed in claim 21, wherein the password is provided by a telephone card.
